(19) United States
(12) Patent Application Publication
(10) Pub. No.: US 2008/0292766 A1
(43) Pub. Date: Nov. 27, 2008

(54) Edible Composition Comprising a Slowly Digestible or Digestion Resistant Oligosaccharide Composition

(76) Inventors: Andrew J. Hoffman, Mount Zion, IL (US); Michael D. Harrison, Decatur, IL (US); Michelle Schwenk, Decatur, IL (US); Lori Napier, Decatur, IL (US); Rachel Wicklund, Decatur, IL (US); Warren Nehmer, Decatur, IL (US); Christopher King, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/124,364

(22) Filed: May 21, 2008

Related U.S. Application Data
(60) Provisional application No. 60/939,941, filed on May 24, 2007.
(60) Provisional application No. 60/947,804, filed on Jul. 3, 2007.
(60) Provisional application No. 60/939,744, filed on May 23, 2007.

(51) Int. Cl. A23L 1/236; A23L 1/09; A23L 1/30; A23L 2/60

(52) U.S. Cl. 426/548; 426/661; 426/648; 426/590

(57) ABSTRACT

An edible composition comprises (1) a starch-derived soluble fiber composition that comprises oligosaccharides that are digestion resistant, oligosaccharides that are slowly digestible, or a combination thereof, and (2) at least one material selected from fructose, sorbitol, pullulan, a non-nutritive high-intensity sweetener, and combinations of any two or more thereof.

This application claims priority from U.S. application 60/939,744, which was filed on May 23, 2007, U.S. application 60/939,941, which was filed on May 24, 2007, and U.S. application 60/947,804, which was filed on Jul. 3, 2007, all of which are incorporated herein by reference.

### BACKGROUND OF THE INVENTION

A variety of carbohydrates are used in food products, such as various sugars and starches. Many of these carbohydrates are digested in the human stomach and small intestine. Dietary fiber in food products, in contrast, is generally not digested in the stomach or small intestine, but is potentially fermentable by microorganisms in the large intestine.

Both in vitro and in vivo tests can be performed to estimate the rate and extent of carbohydrate digestion in humans. The Englyst assay is an in vitro enzyme test that can be used to estimate the amounts of a carbohydrate ingredient that are rapidly digestible, slowly digestible or resistant to digestion. European Journal of Clinical Nutrition (1992) Volume 46 (Suppl. 2), pages S33-S50.

When rapidly digestible carbohydrates are consumed, the bloodstream of the consumer typically displays a peak glycemic response within a short time frame, usually 15 to 45 minutes after the food is eaten. The peak is frequently followed by a hypoglycemic “overshoot” through the action of insulin released by the pancreas. Hypoglycemia is commonly associated with feelings of hunger. When hunger is followed by consumption of rapidly digestible carbohydrates, a vicious cycle of eating, followed shortly thereafter by feelings of hunger can ensue.

### SUMMARY OF THE INVENTION

One aspect of the invention is an edible composition that comprises a soluble fiber composition that is derived from starch and that comprises oligosaccharides that are digestion resistant, oligosaccharides that are slowly digestible, or a combination thereof. The edible composition also comprises at least one material selected from fructose, sorbitol, pullulan, a non-nutritive high-intensity sweetener, and combinations of any two or more thereof.

Another aspect of the invention is a food product that comprises the above-described edible composition. The edible composition can be used a replacement for other sweeteners, such as sucrose, in the food product.

Another aspect of the invention is a method of decreasing the glycemic response of a mammal to a food product. This method comprises replacing a nutritive sweetener in the ingredients of the food product with the above-described edible composition.

### BRIEF DESCRIPTION OF THE DRAWING

FIG. 1 is a graph of the change in blood glucose concentration over time in dogs fed 10 DE maltodextrin or compositions according to the present invention, which are labeled as Blend 1, Blend 2, Blend 3, and Blend 4.

### DESCRIPTION OF SPECIFIC EMBODIMENTS

One aspect of the invention is an edible composition that is suitable for use in foods. The edible composition comprises a soluble fiber composition that is made from starch and that comprises oligosaccharides that are digestion resistant, oligosaccharides that are slowly digestible, or a combination thereof. The edible composition also comprises fructose. The fractions of the soluble fiber composition that are digestion resistant or slowly digestible can be determined by the Englyst assay.

The terms “oligosaccharides” and “saccharide oligomers” are used herein to refer to saccharides comprising at least two saccharide units, for example saccharides having a degree of polymerization (“DP”) of about 2-30. For example, a disaccharide has a DP of 2.

In one embodiment, the composition comprises a major amount of soluble fiber composition on a dry solids basis. In other words, excluding any water that is present, the percentage of soluble fiber composition that is present in the edible composition is greater than or equal to the percentage of any other ingredient.

The soluble fiber composition can be derived from a variety of starch sources, such as cereal grains, potato, or tapioca. The soluble fiber composition can be made from any of a variety of cereal grains, such as corn, wheat, rice, and combinations thereof. When corn is used as the starting material, the soluble fiber composition is sometimes referred to as SCF (soluble corn fiber). Although the abbreviation SCF is used at times in this patent, it should be understood that the soluble fiber composition does not have to be made from corn.

In one embodiment, the starch source is not a genetically modified organism (GMO). For example, the starch source can be non-GMO corn.

It should also be understood that the soluble fiber composition can also contain substances that are not soluble fiber. In many embodiments, soluble fiber will make up the majority of the soluble fiber composition on a dry solids basis. However, there can also be some amounts of insoluble fiber and/or rapidly digestible carbohydrate, for example, in the composition.

Because SCF can, at least in some embodiments, be classified as a corn syrup or maltodextrin, it does not have the regulatory limitations imposed in polydextrose in the U.S. In one embodiment, the soluble fiber composition is produced by a process that comprises:
producing an aqueous composition that comprises at least one oligosaccharide and at least one monosaccharide by saccharification of starch derived from the cereal grain;
fractionating the aqueous composition by a method comprising at least one of membrane filtering and sequential simulated moving bed chromatography to form a monosaccharide-rich stream and a digestion resistant oligosaccharide-rich stream; and
recovering the oligosaccharide-rich stream.

In one specific version of this embodiment, the oligosaccharide-rich stream comprises a minor amount of dextrose and fructose, and the process further comprises contacting the oligosaccharide-rich stream with an isomerization enzyme such that at least some of the dextrose is converted to fructose, thereby producing an isomerized oligosaccharide-rich stream. In another specific version of this embodiment, the oligosaccharide-rich stream comprises a minor amount of monosaccharides, and wherein the process further comprises hydrogenating the oligosaccharide-rich stream to convert at least some of the monosaccharides therein to alcohols, thereby producing a hydrogenated oligosaccharide-rich stream. In yet another specific version of this embodiment, the process further comprises contacting the oligosaccharide-rich stream with a glucosidase enzyme such that at least some of any residual monosaccharides present in the stream are covalently bonded to oligosaccharides or other monosaccharides.

Additional details and information regarding this embodiment are found in U.S. patent application Ser. No. 11/083,347, filed on Mar. 17, 2005, and published as US-2006-0210696-A1, which is incorporated herein by reference.

In another embodiment, the soluble fiber composition is produced by a process comprising:

heating an aqueous feed composition that comprises at least one monosaccharide or linear saccharide oligomer derived from the cereal grain, and that has a solids concentration of at least about 70% by weight, to a temperature of at least about 40° C.; and

contacting the feed composition with at least one catalyst that accelerates the rate of cleavage or formation of glucosyl bonds for a time sufficient to cause formation of non-linear saccharide oligomers, wherein a product composition is produced that contains a higher concentration of non-linear saccharide oligomers than linear saccharide oligomers.

In one specific version of this embodiment, the catalyst is an enzyme that accelerates the rate of cleavage or formation of glucosyl bonds. A glucoamylase enzyme composition is one suitable example. In another specific version of this embodiment, the catalyst is an acid. Suitable acids include hydrochloric acid, sulfuric acid, phosphoric acid, and combinations thereof. In another specific version, the catalyst used in the process comprises a combination of acid and enzyme. The acid and enzyme can be used sequentially in any order (e.g., acid followed by enzyme, or enzyme followed by acid). In another specific version of this embodiment, the feed composition has a solids concentration of about 70-99% and is maintained at a temperature of about 70-180° C. during the contacting with the acid. In yet another specific version of this embodiment, the product composition comprises non-linear saccharide oligomers having a degree of polymerization of at least three in a concentration of at least about 50% by weight on a dry solids basis.

Additional details and information regarding this embodiment are found in U.S. patent application Ser. No. 11/339,306, filed on Jan. 25, 2006, Ser. No. 11/532,219, filed on Sep. 15, 2006, and Ser. No. 11/610,639, filed on Dec. 14, 2006, each of which is incorporated herein by reference.

The soluble fiber composition can be used in any of several different physical forms, such as a syrup or concentrated syrup solids. In one embodiment, the soluble fiber composition is in particulate form. The particulates can be held together by a binder, such as a binder composition that comprises a major amount of maltodextrin. An agglomeration of particulates can have advantages in terms of rate of dissolution and dispersion. This can be useful in applications where more rapid dissolution and lower shear rates of mixing are important, such as table top sugar replacement, table top fiber supplementation, and on-the-go dry powder drink mix products.

Optionally, the edible composition can also comprise additional nutritive or non-nutritive saccharides and/or polysaccharides. In one embodiment, the edible composition comprises sorbitol, pullulan, or a combination thereof. Sorbitol delivers about 60% of the sweetness of sugar to foods, but at a significant reduction in caloric content (2.6 vs. 4.0 kcal/g, Livesay) and with a negligible glycemic response. Pullulan gum is a slowly digestible carbohydrate that gives about a 50% relative glycemic response in humans compared to rapidly digestible carbohydrate, but may deliver similar caloric content as sugar to foods.

In one embodiment, the edible composition comprises about 50-99% soluble fiber composition, 0-50% fructose, 0-33% pullulan, and 0-33% sorbitol, provided that the concentration of at least one of fructose, pullulan, or sorbitol is at least 1%. (All of these percentages are by weight.) In another embodiment, the edible composition comprises about 60-80% soluble fiber composition, 1-20% fructose, 0-20% pullulan, and 0-20% sorbitol. In yet another embodiment, the edible composition comprises about 65-75% soluble fiber composition, 5-15% fructose, 5-15% pullulan, and 5-15% sorbitol. In embodiments that comprise a high intensity sweetener, the concentration of that ingredient can be about 0.001-0.5%.

The edible composition optionally can also contain resistant starch or other fiber sources.

In order to make the edible composition suitable for use as a sweetener composition in food, in many cases it will be desirable for it also to include a non-nutritive high-intensity sweetener. Suitable examples of such non-nutritive high-intensity sweeteners include, but are not limited to sucralose, acesulfame potassium, aspartame, and combinations thereof.

The edible composition can be used in food products. It should be understood that the terms “food” and “food product” are used in a broad sense herein to include a variety of substances that can be ingested by humans, such as beverages and medicinal capsules or tablets. Suitable food products in which the edible composition can be used include, but are not limited to baked foods, breakfast cereal, dairy products, confections, jams and jellies, beverages, fillings, extruded and sheeted snacks, gelatin desserts, snack bars, cheese and cheese sauces, edible and water-soluble films, soups, syrups, sauces, dressings, creamers, icings, frostings, glazes, pet food, tortillas, meat and fish, dried fruit, infant and toddler food, and batters and breadings.

Another aspect of the invention is a method of decreasing the glycemic response of a mammal to a food product. The method involves replacing a nutritive sweetener in the ingredients of the food product with the above-described edible composition. The edible composition can be used for total or partial replacement of nutritive sweeteners such as sucrose, high fructose corn syrup (HFCS), fructose, dextrose, regular corn syrup, or corn syrup solids in food products.

The inclusion of the edible composition in food products can provide a number of benefits, such as lower glycemic response, lower glycemic index, and lower glycemic load than a similar food product in which a conventional carbohydrate is used. Further, because at least some of the oligosaccharides are either only digested very slowly or are not digested at all in the human stomach or small intestine, the caloric content of the food product can be reduced.

The edible composition can be added to food products as a source of soluble fiber without having a negative impact on flavor, mouth feel, or texture. Soluble fiber in food can have several beneficial effects, such as reducing cholesterol, attenuating blood glucose, and maintaining gastrointestinal health.

The edible composition is particularly useful in foods in which nutritive sweetener systems and other similar carbohydrates are included at 2 to 3 grams (or more) per serving.

Food products that contain the edible composition can be used to help control the blood glucose concentration in mammals, such as humans, that suffer from diabetes. When the food product is consumed by the mammal, the slowly digestible and/or digestion resistant components in the food product can cause a more moderate relative glycemic response in the bloodstream, which can be beneficial for diabetes patients. “Control” in this context should be understood as a relative term; i.e., the glycemic response can be improved relative to that occurring when the same mammal consumes a similar food product that does not contain such digestion-resistant and/or slowly digestible components, although the glycemic response may not necessarily be equivalent to what would be observed in a mammal that does not suffer from diabetes.

Table 1 shows the relative sweetness, relative glycemic response (RGR), caloric content, and dietary fiber content of the ingredients sucralose, fructose, sucrose, sorbitol, Soluble Corn Fiber (SCF), and pullulan.

The Soluble Corn Fiber (SCF) sample that was tested for Table 1 was nearly colorless and mildly sweet. A measurement using AOAC method 2001.03 showed the material to contain about 75% digestion resistant carbohydrate on a dry solids basis. SCF has about a 30% relative glycemic response (RGR, compared to 25 g dextrose as a control) in humans. Furthermore, true metabolizable energy (TME, Parsons) measurements in poultry have determined a caloric content of about 2 kcal/gram for the ingredient.

TABLE 1

| | Relative | Canine | Calories | Dietary |
|---|---|---|---|---|
| | Sweetness | RGR | kcal/g | Fiber |
| Sucralose | 600 | 0% | n.d. | 0 |
| Fructose | 1.5 | 3% | 4.0 | 0 |
| Sucrose | 1 | 19% | 4.0 | 0 |
| Sorbitol | 0.6 | 11% | 2.6 | 0 |
| SCF | 0.1 | 40% | 2.0 | 75% |
| Pullulan | 0 | 13% | 3.9 | 80% |

(Dietary Fiber was measured by AOAC 2001.03. RGR and calorie methods are described below.)

Relative sweetness is a sensory measurement in which table sugar (sucrose) is defined as having a relative sweetness of one. Sucralose is assumed to have a negligible glycemic response and caloric content at typical usage levels. Likewise, sucralose, fructose, sucrose and sorbitol are excluded from contributing to dietary fiber by definition. Monosaccharides and disaccharides (e.g., sucralose, fructose, and sucrose) are quantified as sugars on food labels and are always excluded from dietary fiber calculations. SCF was assigned a relative sweetness of 0.1 due to its monosaccharide content of about 10-15% and is estimated to possess energy content of about 2 kcal/gram based on results of in vivo TME measurements. A “good source of dietary fiber” claim on a product label can be achieved by delivering 3 g of dietary fiber per serving. For SCF, inclusion of 4 grams per serving will deliver 3 grams of dietary fiber based upon its analyzed fiber content of 75%.

“Sustained energy” is used herein to include not only the energy derived from fully digestible carbohydrate, but also to include the energy derived from short chain fatty acids (SCFA) formed as metabolic products through fermentation by the microbiota of the large intestine. An average value of about 2 kcal/gram has been proposed for the caloric content (energy value) of the SCFA formed by fermentation of the dietary fibers (Livesay). In contrast, fully digestible carbohydrate implies absorption of hydrolyzed monosaccharide by the small intestine, resulting in the typical carbohydrate caloric content of about 4 kcal/gram.

As mentioned above, rapidly digestible carbohydrate typically leads to a peak glycemic response that occurs within a short time frame, usually 15 to 45 minutes. The peak is frequently followed by a hypoglycemic “overshoot” through the action of insulin released by the pancreas. Hypoglycemia is commonly associated with feelings of hunger. When hunger is followed by rapidly digestible carbohydrate consumption, then a vicious cycle of eating, followed shortly thereafter by feelings of hunger can ensue. A more slowly digestible carbohydrate leads to a more gradually increasing blood sugar response, followed by a slowly decreasing plateau that avoids the hypoglycemic overshoot, thus avoiding the vicious cycle of consumption followed by hunger as described above.

In some embodiments, the edible composition provides a sustained energy carbohydrate that has not only the characteristic of slowly digestible carbohydrate (gradually increasing glycemic response followed by slowly decreasing plateau), but also has a digestion resistant fraction that passes into the large intestine and becomes a fermentation substrate for the microbiota residing there. Fermentation releases short chain fatty acids (SCFA) that are absorbed by the host and serve as an energy source themselves. In fact, butyrate is a preferred energy source for the host cells lining the colon, thus promoting healthy cell function and resistance to disease and cancer.

In vitro testing (more fully described in the Example 2 below) has shown that the compositions described in this patent are capable of delivering digestion resistant carbohydrate to the large bowel, and that they are capable of being transformed into SCFA (capable of delivering sustained energy) after fermentation by organisms inoculated from fresh fecal material.

TABLE 2

| | Calories | Calorie |
|---|---|---|
| | kcal/g | Method |
| Sucrose | 4.0 | given |
| Fructose | 4.0 | given |
| Pullulan | 3.9 | TME |
| Sorbitol | 2.6 | Livesay |
| SCF | 2.0 | TME |
| Polydextrose | 1.0 | TME |

Therefore, the edible composition can be used to replace traditional sugar sweeteners and provide sustained energy and dietary fiber to nearly any food item, while simultaneously controlling sweetness at reduced calories and glycemic load. Fructose (and optionally sorbitol) can be used at the minimum ratio necessary to dampen the glycemic response of SCF, leading to low glycemic load and reduced caloric content. The soluble fiber added by SCF and SCF/pullulan blends is soluble, with good flavor and low color and therefore is highly versatile in food systems. SCF/pullulan blends can provide fiber benefits over either ingredient alone with respect to dietary tolerance and prebiotic effect.

One embodiment of the invention is a single serving packaged sweetener composition. The composition comprises a starch-derived soluble fiber composition that is made from cereal grain and that comprises oligosaccharides that are digestion resistant, oligosaccharides that are slowly digestible, or a combination thereof. The composition also comprises a non-nutritive high-intensity sweetener (e.g., sucralose), and is in a package that is adapted to be opened by a consumer. In some embodiments, the packaged sweetener composition further comprises at least one material selected from fructose, pullulan, sorbitol, and combinations of two or more thereof, and can optionally also comprise maltodextrin. In one particular embodiment, the starch-derived soluble fiber composition comprises about 70-99% by weight of the packaged sweetener composition.

Such compositions that contain agglomerated soluble corn fiber (SCF) can have greatly improved dispersibility and dissolution rate compared to SCF by itself. An aqueous solution of, for example, 10 DE maltodextrin can be used to bind raw SCF particles together in an agglomeration process. This results in a product with lower bulk density (e.g., in some embodiments, 0.1-0.85 g per cubic centimeter, or in some other embodiments, 0.45-0.65 g per cubic centimeter). The enhanced dispersibility and dissolution rate of the agglomerated product can be valuable especially in applications where shorter times and lower shear rates of mixing are critical, such as table top sugar replacement, table top fiber supplementation, and on-the-go dry powder drink mix products.

Another embodiment of the invention relates to a corn syrup composition that comprises a starch-derived soluble fiber composition (as described above), fructose, and a non-nutritive high-intensity sweetener (e.g., sucralose). In one particular embodiment, the composition comprises about 35-50% by weight fructose and about 35-50% by weight of the soluble fiber composition on a dry solids basis. This corn syrup composition can be blended with conventional high fructose corn syrup to produce a sweetener composition that has a lower caloric content than HFCS by itself.

Another embodiment of the invention relates to an edible calcium supplement that comprises a starch-derived soluble fiber composition (as described above) and at least one calcium compound. The calcium compound can be a calcium salt, such as calcium citrate, calcium carbonate, or a combination thereof. A calcium supplement containing SCF could enhance calcium absorption due to the pH lowering effect of SCF fermentation, rendering the supplement more effective.

Another embodiment of the invention relates to a diet beverage that comprises a starch-derived soluble fiber composition (as described above) pullulan, a non-nutritive high-intensity sweetener (e.g., sucralose), and at least one flavor. In one particular embodiment, the beverage comprises about 3-7% by weight of the starch-derived soluble fiber composition and about 0.1-3% by weight pullulan.

This diet beverage can help overcome taste problems observed with previous diet beverages. In particular, many diet beverages do not taste the same as their full sugar counterparts. The sensory experience associated with consumption of a diet vs. a full sugar beverage is multifaceted, but two of the major sensory differences can be classified in terms of “sweetness” and “mouthfeel.” Diet beverages derive their sweetness through inclusion of high intensity sweeteners (HIS) such as sucralose, aspartame and acesulfame potassium. A very low concentration of HIS, typically in the range of 0.02% to 0.06% by weight, is used in diet beverages to replace the sugar or high fructose corn syrup that is used (at about 10% by weight) in a full calorie beverage. This replacement affords lower caloric content at a similar sweetness for a diet beverage, but the large difference in dissolved solids concentration (0.06% vs. 10%) gives the diet beverage a significantly lower viscosity and hence a much more watery mouthfeel. Not only is watery mouthfeel a drawback in the sensory experience of diet beverages, but the diminished solids content also changes the intensity and timeframe of sensory perception for the sweet and tart flavors in a diet beverage compared to its full sugar counterpart.

These undesirable characteristics of diet beverages can be eliminated or greatly diminished by using a combination of pullulan (e.g., pullulan having weight average molecular weight=99,600 with polydispersity of 18.9) and soluble corn fiber. This combination not only adds viscosity and mouthfeel back to the diet beverage, but also moves the sensory experience of sweet and tart flavors much closer to that found in a full sugar beverage.

Certain embodiments of the invention can be further understood from the following examples.

### Example 1

### Canine Glycemic Response Testing Protocol

The following procedure was used to evaluate the glycemic response of several ingredients and blends of ingredients in dogs.

Animals. Purpose-bred female dogs (n=5; Butler Farms USA, Clyde, N.Y.) with hound bloodlines, a mean initial body weight of 25.1 kg (range, 19.9 to 29.5 kg), a mean age of 5 yr will be used.

Dietary treatments. Experimental carbohydrates were grouped in sets of 4 and each set was compared to a maltodextrin control (Star-Dri 10; Tate & Lyle). Dogs consumed 25-50 g of carbohydrate in approximately 240-mL dd (double distilled) water for the meal tolerance test. Quantity of dose WAS measured using a disposable 60 cc syringe (without needle) and offered to dogs over a 10 min period. Amount consumed was based on ability to dissolve in 240-mL water. The same amount of all carbohydrates was dosed to all dogs within each 5×5 Latin Square. In order to get carbohydrate sources into solution/suspension, water and carbohydrate was mixed using a stir plate. Dogs consumed all of the test carbohydrate within 10 min so that accurate measures of blood glucose are taken.

Experimental design. A series of 5×5 Latin square designs were used in which dogs were subjected to three separate 3 hr meal tolerance tests. Tolerance tests were spaced 3 to 4 days apart. After 15 hr of food deprivation, dogs will consume their allotted treatment.

All dogs were fed the same commercial diet (Tams Weight Control®; The Iams Co., Lewsburg, Ohio). The main ingredients of the diet were corn meal, chicken, ground whole grain sorghum, chicken by-product meal, ground whole grain barley, and fish meal. Water was available ad libitum. At 1700 hr on the evening before each meal tolerance test, any remaining food was removed, and dogs were food-deprived for 15 hr, during which time they consumed only water. The morning of the meal tolerance test, a blood sample was obtained from food-deprived dogs. Dogs were then dosed with the appropriate carbohydrate solution, and additional blood samples were taken at 15, 30, 45, 60, 90, 120, 150, and 180 min postprandially. Approximately 1-mL of blood was collected in a syringe via jugular or radial venipuncture. An aliquot of blood was taken immediately for glucose analysis.

Chemical analyses. Immediately following collection, blood samples were assayed for glucose by the glucose oxidase method utilizing a Precision-G Blood Glucose Testing System (Medisense, Inc., Bedford, Mass.). The precision of this testing system for the range of values obtained is 3.4 to 3.7% (coefficient of variation), as reported by the manufacturer.

Statistical analysis. Data for within each Latin Square was analyzed by the Mixed models procedure of SAS (SAS Institute, Cary, N.C.). The statistical model included the fixed effect of treatment and the random effects of animal and period. Treatment least squares means were compared using the Tukey method. A probability of P<0.05 was accepted as being statistically significant. Probabilities between 0.06 and 0.10 were referred to as trends.

This protocol was used with the following samples (pullulan is abbreviated as pu”, soluble corn fiber as “SCF”, sorbitol as “sorb”, and fructose as “fruc”):

10 DE maltodextrin

CHO Blend 1 (1:7:1:1 pu:SCF:sorb:fruc weight ratio)

CHO Blend 2 (3:5:1:1 pu:SCF:sorb:fruc weight ratio)

CHO Blend 3 (3:3:2:2 pu:SCF:sorb:fruc weight ratio)

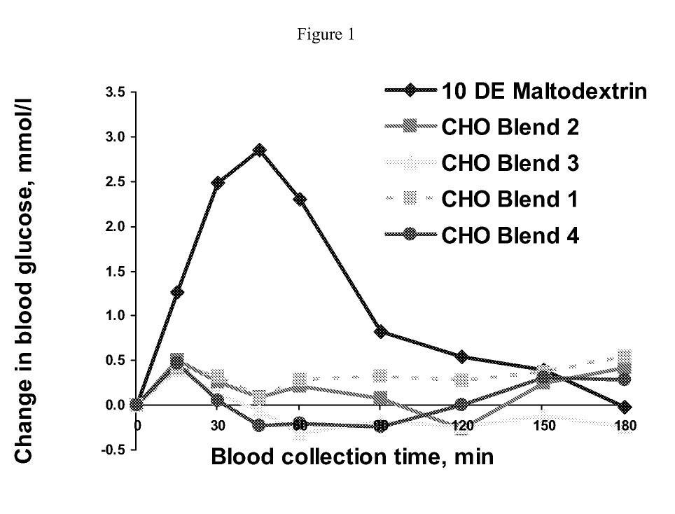

CHO Blend 4 (2:6:1:1 pu:SCF:sorb:fruc weight ratio) The results are shown in FIG. 1 and in Table 2 below.

TABLE 2
Incremental area under the curve and relative glycemic response for dogs

| | 10 DE | CHO | CHO | CHO | CHO | |
|---|---|---|---|---|---|---|
| Item | Maltodextrin | Blend 2 | Blend 3 | Blend 1 | Blend 4 | SEM |
| N | 5 | 5 | 5 | 5 | 5 | |
| Time to glucose peak, min | 42^{a} | 27^{a} | 12^{a} | 99^{b} | 15^{a} | 16.54 |
| Incremental area under the | 210.40^{b} | 23.84^{a} | 10.54^{a} | 59.79^{a} | 8.83^{a} | 23.53 |
| curve for glucose | | | | | | |
| Relative glycemic response | 100.00^{c} | 25.76^{ab} | 7.05^{ab} | 38.64^{b} | 5.19^{a} | 13.30 |

^{abc}Means in the same row with different superscripts are different (P < 0.05).

As shown by the data, a composition that contained a minor portion of fructose (fruc), sorbitol (sorb) and pullulan (pu) together with the SCF gave a muted glycemic response in canines. For example, SCF by itself gave an RGR of 40%, while the 1:7:1:1 pu:SCF:sorb:fruc (CHO Blend 1) weight ratio blend lowered the RGR down to 39%. Likewise, the 3:5:1:1 pu:SCF:sorb:fruc (CHO Blend 2) weight ratio blend lowered the RGR down to 26%. The 3:3:2:2 pu:SCF:sorb:fruc (CHO Blend 3) weight ratio blend lowered the RGR down to 7%. The 2:6:1:1 pu:SCF:sorb:fruc (CHO Blend 4) weight ratio blend lowered the RGR down to 5%. A summary of this information is shown below in Table 3:

TABLE 3

| | Canine | Calories | Calorie |
|---|---|---|---|
| | RGR | kcal/g | Method |
| SCF | 40% | 2.0 | TME |
| CHO Blend 1 (1:7:1:1, pu:SCF:sorb:fruc) | 39% | 2.5 | calc'd |
| CHO Blend 2 (3:5:1:1, pu:SCF:sorb:fruc) | 26% | 2.8 | calc'd |
| Sucrose | 19% | 4.0 | given |
| Pullulan | 13% | 3.9 | TME |
| Sorbitol | 11% | 2.6 | given |
| CHO Blend 3 (3:3:2:2, pu:SCF:sorb:fruc) | 7% | 3.1 | calc'd |
| CHO Blend 4 (2:6:1:1, pu:SCF:sorb:fruc) | 5% | 2.6 | calc'd |
| Fructose | 3% | 4.0 | given |

### Example 2

### In Vitro Fermentation

### Three Stage Monogastric

The following reagents and procedure were used to evaluate the production of SCFA when certain compositions were fermented in vitro.

### REFERENCES

Boisen, S., In Vitro Digestion for Pigs and Poultry, ed. M. F. Fuller, 1991, 135-145
Boisen and Eggum, Nutr. Res. Rev. 1991, 4:141-162
Bourquin, Titgemeyer and Fahey, 1993, J. Nutr. 123(5):860-869

Reagents:

1. Phosphate Buffer I, 0.1M, pH 6.0—Dissolve 2.1 g of sodium phosphate dibasic, anhydrous, and 11.76 g of sodium phosphate monobasic, monohydrate in a 1 liter volumetric flask. Bring up to volume with distilled water. Check by pH measurement. This solution will keep for up to 48 hrs if kept refrigerated.

2. Hydrochloric Acid, 0.2N—Place 16.7 ml HCl in a 1 liter volumetric flask. Bring up to volume with dd water.

3. HCl:Pepsin Solution—Place 1 g pepsin (Sigma P-7000) in a 100 ml volumetric flask. Dissolve in 50 ml distilled water. Add 10 ml HCl. Bring up to volume with distilled water. Prepare fresh on day of use.

4. Chloramphenicol Solution—Place 0.5 g chloramphenicol (Sigma C-0378) in a 100 ml volumetric flask. Bring up to volume with 95% ethanol.

5. Sodium Hydroxide Solution, 0.6N-Place 24 g NaOH in a 1 liter volumetric flask. Bring up to volume with dd water.

6. Phosphate Buffer II, 0.2M, pH 6.8—Dissolve 16.5 g of sodium phosphate dibasic, anhydrous, and 11.56 g of sodium phosphate monobasic, monohydrate in a 1 liter volumetric flask. Bring up to volume with distilled water. Check by pH measurement. This solution will keep for up to 48 hrs if kept refrigerated.

7. Pancreatin Solution—Place 5 g porcine pancreatin (Sigma P-1750) in a 100 ml volumetric flask. Bring up to volume with phosphate buffer II. Prepare fresh on day of use.

8. Mineral Solution A—In a 1 liter volumetric flask, place 5.4 g sodium chloride, 2.7 g potassium phosphate monobasic anhydrous, 0.18 g calcium chloride dihydrate, 0.12 g magnesium chloride hexahydrate, 0.06 g manganese chloride tetrahydrate, 0.06 g cobalt chloride hexahydrate, and 5.4 g ammonium sulfate. Bring up to volume with dd water. Store in the refrigerator. Stable.

9. Mineral Solution B—Place 2.7 g potassium phosphate dibasic anhydrous in a 1 liter volumetric flask. Bring up to volume with dd water. Store in the refrigerator. Stable 48 hrs.

10. Trace Mineral Solution—In a 1 liter volumetric flask, place 0.5 g EDTA (disodium salt), 0.2 g ferrous sulfate heptahydrate, 0.01 g zinc sulfate heptahydrate, 0.003 g manganese chloride tetrahydrate, 0.03 g phosphoric acid, 0.02 g cobalt chloride hexahydrate, 0.001 g cupric chloride dihydrate, 0.002 g nickelous chloride hexahydrate, and 0.003 g sodium molybdate dihydrate. Bring up to volume with dd water. Store in the refrigerator. Stable.

11. Water Soluble Vitamin Solution—In a 100 ml volumetric flask, place 0.0025 g vitamin B-12. Bring up to volume with dd water. Set aside. In a 1 liter volumetric, place 0.1 g thiamin HCl, 0.01 g pantothenic acid, 0.1 g niacin, 0.1 g pyridoxine, and 0.005 g p-aminobenzoic acid. Add 10 ml of the vitamin B-12 mixture. Bring up to volume with dd water. Store in the refrigerator. Stable.

12. Folate:Biotin Solution—In a 1 liter volumetric flask, place 0.01 g folic acid, 0.002 g biotin, and 0.1 g ammonium carbonate. Bring up to volume with dd water. Store in the refrigerator. Stable.

13. Riboflavin Solution—In a 100 ml volumetric flask, place 0.001 g riboflavin and 0.13 g HEPES. Bring up to volume with dd water. Store in the refrigerator. Stable.

14. Hemin Solution—In a 100 ml volumetric flask, place 0.05 g hemin and 0.04 g sodium hydroxide. Bring up to volume with dd water. Store in the refrigerator. Stable.

15. Short Chain Fatty Acid Mix—Mix together equal volumes of n-valerate, isovalerate, isobutyrate, and DL-2-methylbutyrate.

16. Resazurin Solution 0.1%—Place 0.1 g resazurin in a 100 ml volumetric flask. Bring up to volume with dd water. Stable.

17. Media—In an autoclavable flask, mix 330 ml of Solution A, 330 ml of Solution B, 10 ml of Trace Mineral Solution, 1 ml of Resazurin Solution, 0.5 g of yeast extract, 0.5 g of trypticase, 4 g of sodium carbonate, 0.5 g cysteine HCl monohydrate and 296 ml dd water. Reduce for 30 minutes with copper dried carbon dioxide, seal and autoclave for 20 minutes. After the solution has cooled, add 0.4 ml of Short Chain Fatty Acid Mix. Add, filter sterilized, 20 ml of Water Soluble Vitamin Solution, 5 ml of Folate:Biotin Solution, 5 ml of Riboflavin Solution, and 5 ml of Hemin Solution.

18. Mineral Solution No. 1—Place 3 g potassium phosphate dibasic anhydrous and 1 g sodium citrate dihydrate in a 500 ml volumetric flask. Bring up to volume with dd water. Store in the refrigerator. Stable.

19. Mineral Solution No. 2—In a 500 ml volumetric flask, dissolve successively 6 g sodium chloride, 6 g ammonium sulfate, 3 g potassium phosphate monobasic anhydrous, 0.6 g calcium chloride dihydrate, 1.23 g magnesium sulfate heptahydrate, and 10 g sodium citrate dihydrate. Bring up to volume with dd water. Store in the refrigerator. Stable.

20. Sodium Bicarbonate Solution—Place 91 g sodium bicarbonate in a 1 liter volumetric flask. Bring up to volume with dd water. Store at room temperature. Stable.

21. Anaerobic Diluting Solution—Mix together 37.5 ml of Mineral Solution No. 1, 37.5 ml of Mineral Solution No. 2, 1 ml of Resazurin Solution, 70 ml of Sodium Bicarbonate Solution, and 854 ml dd water. Purge with dried CO₂ for 30 minutes. Add 0.5 g cysteine HCl monohydrate and allow to dissolve. Dispense required amounts into carbon dioxide purged autoclavable containers. Seal and autoclave 20 minutes. Discard any containers that remain pink after autoclaving.

Procedure:

1. Place Whatman 541 filter paper in a 105° C. oven overnight and weigh the next day.

2. In triplicate, weigh 0.5 g samples into 50 ml centrifuge tubes. Also, prepare three blanks. Samples should be ground to 1 mm.

3. Add 12.5 ml phosphate buffer I to each tube. Mix gently.

4. Add 5 ml 0.2N HCl to each tube. Adjust to pH 2 with HCl or NaOH.

5. Add 0.5 ml HCl:pepsin to each tube.

6. Add 0.25 ml chloramphenicol solution to each tube.

7. Stopper tubes. Mix gently. Incubate at 39° C. for 6 hours. Mix on a regular basis.

8. After incubation, add 2.5 ml 0.6N NaOH to each tube.

9. Add 5 ml phosphate buffer II. Mix gently. Adjust to pH 6.8 with HCl or NaOH.

10. Add 0.5 ml pancreatin solution to each tube.

11. Stopper tubes. Mix gently. Incubate at 39° C. for 18 hours. Mix on a regular basis.

12. Centrifuge the tubes for 15 minutes at 6,750×g. Decant and discard the supernate.

13. Collect fresh feces in plastic bags. Seal the bags after expressing excess air and maintain the samples at 37° C.

14. Dilute feces 1:10 in anaerobic diluting solution by blending it for 15 seconds in a Waring blender under CO₂. Filter blended, diluted feces through 4 layers of cheesecloth into serum bottles under CO₂ and seal.

15. Add 26 ml media to each tube. Purge with CO₂. Seal with stoppers with Bunsen valves.

16. Inoculate the tubes with 4 ml of diluted feces. Mix gently.

17. Incubate at 39° C. for 18 hours. Mix on a regular basis.

18. After incubation, transfer the contents of the tubes to 400 ml Berzelius beakers. Add 120 ml of 95% ethanol and allow to precipitate for 1 hr.

If SCFA analysis is desired, pipette off a 2 ml sub-sample from the tube and precipitate the remaining 28 ml with 112 ml 95% ethanol.

19. Filter the precipitated sample through previously tared Whatman 541 filter paper. Rinse with three 10 ml portions of 78% ethanol, 2 portions of 95% ethanol, and 2 portions of acetone. Dry at 105° C. overnight and weigh. Samples may be ashed to determine organic matter residue.

This protocol was used to test the materials listed in Table 4:

TABLE 4
In Vitro Fermentation Results

| | | | | SCFA Yield | | |
|---|---|---|---|---|---|---|
| | | | | (wt % from ingredient) | | |
| Test Agent Identifiers | % digestible | % fermentable | % unchanged | Acetate | Propionate | Butyrate |
| Fructose | 85% | 11% | 4% | 0% | 0% | 11% |
| Sorbitol | 0% | 45% | 55% | 0% | 0% | 45% |
| Pullulan | 78% | 12% | 10% | 0% | 4% | 7% |
| Sol Fiber Dextrin | 38% | 13% | 48% | 0% | 0% | 13% |
| SCF55 | 45% | 13% | 42% | 1% | 3% | 9% |
| HSCF55 | 41% | 36% | 23% | 14% | 4% | 17% |
| 3:1 SCF55:Fructose | 67% | 11% | 22% | 0% | 0% | 11% |
| 1:1 SCF55:Fructose | 70% | 16% | 14% | 0% | 0% | 16% |

SCF55—Soluble Corn Fiber with 55% fiber
HSCF55—Hydrogenated Soluble Corn Fiber with 55% fiber
Sol Fiber Dextrin - Tapioca Dextrin Food Ingredient

### Example 3

### Drink Dry Mix with Fiber

A dry drink mix was prepared with the following ingredients (proportions listed on a weight basis):

| | |
|---|---|
| CHO Blend 1 | 93.56 |
| Citric Acid | 3.01 |
| Strawberry Flavor | 2.01 |
| Kiwi Flavor | 1.00 |
| Sucralose, dry | 0.40 |
| Tricalcium Phosphate | 0.02 |
| | 100.0 |

The product was prepared as follows: Dry blend using controlled atmosphere, low humidity. Add 4.98 g per 100 ml of water. Mix until dissolved.

### Example 4

### Carbonated Soft Drink

A soft drink mix was prepared with the following ingredients:

| | |
|---|---|
| CHO Blend 1 | 23.28 |
| Citric Acid | 0.63 |
| Caffeine | 0.06 |
| Sodium citrate | 0.10 |
| Potassium sorbate | 0.05 |
| Sucralose liquid concentrate | 0.19 |
| Lemon-lime flavor | 0.30 |
| Filtered water | 75.39 |
| | 100.0 |

The product was prepared as follows: Dissolve the carbohydrate blend into water. Add the preservative and completely dissolve. Add acid. Then dissolve caffeine and add flavors. This makes a concentrate. Use the concentrate at a 5:1 throw in a finished beverage.

### Example 5

### Rehydration Drink

A drink mix was prepared with the following ingredients:

| | |
|---|---|
| CHO Blend 1 | 84.91 |
| Citric acid | 2.73 |
| Malic acid | 1.82 |
| Sodium Chloride | 1.18 |
| Sodium Citrate, Dihydrate | 1.55 |
| Potassium Citrate, Monohydrate | 1.82 |
| Tricalcium phosphate, anticaking agent | 0.02 |
| Sucralose, micronized | 0.45 |
| Grape flavor | 5.47 |
| Red color #40 | 0.04 |
| Blue color #1 | 0.01 |
| | 100.00 |

The product was prepared as follows: Dry blend using controlled atmosphere, low humidity. Add 5.48 g per 100 ml of water mix until dissolved.

### Example 6

### Orange Mango Pasteurized Beverage

A beverage mix was prepared with the following ingredients:

| | |
|---|---|
| CHO Blend 1 | 4.658 |
| Citric acid | 0.17 |
| Malic acid | 0.07 |
| Sodium Chloride | 0.065 |
| Sodium Citrate, Dihydrate | 0.085 |
| Potassium Citrate, Monohydrate | 0.10 |
| Sucralose, micronized | 0.035 |
| Red color #40 (1% solution) | 0.17 |
| Yellow Color #5 (5% solution) | 0.43 |
| Mango Flavor | 0.20 |
| Orange flavor | 0.20 |
| Filtered Water | 93.817 |
| | 100.00 |

The product was prepared as follows: Dissolve dry ingredients into water. Pasteurize at 190° F. for 30 seconds. Hot fill into bottles. Cool.

### Example 7

### Dry Pudding Mix

A pudding mix was prepared with the following ingredients:

| | |
|---|---|
| MiraSperse 2000 | 37.275 |
| (Tate & Lyle, food starch modified) | |
| CHO Blend 1 | 52.319 |
| Tetrasodium pyrophosphate | 2.572 |
| Disodium Phosphate | 2.572 |
| Emulsifier, bealite EV | 1.959 |
| Titanium dioxide | 1.225 |
| Vanilla flavor | 0.98 |
| Salt | 0.796 |
| Sucralose, dry | 0.230 |
| Baker's egg shade color | 0.037 |
| Acesulfame-K | 0.036 |
| | 100.00 |

The product was prepared as follows: Dry blend using controlled atmosphere, low humidity. Add 52.26 g in two cups of milk. Mix on high speed for 2 minutes. Let sit 5 minutes before eating.

### Example 8

### Wire Cut Cookie

A cookie mix was prepared with the following ingredients:

| | |
|---|---|
| Shortening | 18.22 |
| Sugar | 11.72 |
| CHO blend 1 | 6.50 |
| Salt | 0.42 |
| Vanilla Flavor | 0.21 |
| Chocolate flavor | 0.21 |
| Water | 5.88 |
| Liquid Caramel Color | 0.21 |
| Sucralose 25% solution | 0.047 |
| Isosweet 100 (HFCS) | 0.85 |
| Sweet whey | 0.42 |
| Pastry flour | 27.42 |
| Resistant Starch | 12.00 |
| Baking Soda | 0.64 |
| Chocolate chips - mini | 15.25 |
| | 100.00 |

The product was prepared as follows: Stir together shortening, sugar, CHO blend, and salt in Kitchenaid mixer. Scrape sides, stir on speed 2 for 2 minutes. Add flavor, water, color, sucralose, Isosweet, resistant starch, and whey. Scrape down bowl and stir on speed 1 for 1 minute. Scrape down bowl and mix on speed 2 for 2 minutes. Scrape down bowl and add rest of ingredients except chips. Stir on speed 1 for one minute, scrape bowl after 30 seconds. Shape 48 g into 1.5″ cookie cutter and cut 12 g cookies with a wire cutter. Bake at 425° F. on ½ sheet pan with a single parchment for 6:45 minutes. Let cool on pan.

### Example 9

### Cookie

A mix was prepared with the following ingredients:

¾ c CHO blend 1 (replaces standard sugar 1:1)

¾ c brown sugar

1 c butter or margarine

The product was prepared as follows: Cream sugars and butter. Add 2 eggs and 1 t vanilla. Mix well. Add 2¼ c flour, 1 t baking soda, and 1 t salt. Blend well. Add 12 oz of chocolate chips, scoop onto cookie sheet, and bake at 375° F. for 7-10 minutes.

### Example 10

### Table Sugar Replacement Version 1

### BSR1, recipe for 500 gram Batch

A table top sugar replacer mix was prepared with the following ingredients:

| | |
|---|---|
| Core M-60 | 8.3 grams |
| Soluble Corn Fiber | 491.7 grams |

Core M-60 is 10% sucralose by weight on 10 DE maltodextrin. Sucralose is 600 times sweeter than table sugar by weight. The SCF gives 3 grams of dietary fiber per 4 g teaspoonful. This blended ingredient gives the same sweetness but half the calories as table sugar by weight.

### Example 11

### Table Sugar Replacement Version 2

### TSR2, recipe for 500 gram Batch

A table top sugar replacer mix was prepared with the following ingredients:

| | |
|---|---|
| Sucralose | 0.83 grams |
| Soluble Corn Fiber | 499.17 grams |

### Example 12

### High Fructose Corn Syrup Fiber

### HFCSF 42, 71% ds, Recipe for 645 g Batch

A mix was prepared as follows:

Prepare 395 grams of a 67.2% by weight solution of TSR2 in water (from Example 11 above). Blend in 250 grams of a 77% by weight solution of fructose (Krystar® Liquid) and thoroughly mix the two solutions. This gives a syrup product with 71% dry solids content, 42% fructose on a dry solids basis and 43.5% fiber on a dry solids basis. This syrup also provides 29% fewer calories than an equal quantity of a standard High Fructose Corn Syrup (HFCS) such as ISOSWEET 100® (Tate & Lyle).

This material could be blended with an HFCS with similar dry solids and fructose concentration (ISOSWEET 100®) in order to adjust fiber level and calorie reduction to fit the needs of nearly any food product or beverage any application.

### Example 13

### High Fructose Corn Syrup Fiber

### HFCSF 42, 80% ds, recipe for 573 g Batch

A mix was prepared as follows:

Prepare 323 grams of a 82.3% by weight solution of TSR2 in water (from Example 11 above). Blend in 250 grams of a 77% by weight solution of fructose (Krystar® Liquid) and thoroughly mix the two solutions. This gives a syrup product with 80% dry solids content, 42% fructose on a dry solids basis and 43.5% fiber on a dry solids basis. This syrup also provides 29% fewer calories than an equal quantity of a standard HFCS such as ISOSWEET 180®.

This material could be blended with an HFCS with similar dry solids and fructose concentration (ISOSWEET 180®) in order to adjust fiber level and calorie reduction to fit the needs of nearly any food product or beverage any application.

### Example 14

### High Fructose Corn Syrup Fiber

### HFCSF 55, 77% ds, recipe for 454 g Batch

A mix was prepared as follows:

Prepare 204 grams of a 77% by weight solution of TSR2 in water (from Example 11 above). Blend in 250 grams of a 77% by weight solution of fructose (Krystar® Liquid) and thoroughly mix the two solutions. This gives a syrup product with 77% dry solids content, 55% fructose on a dry solids basis and 33.7% fiber on a dry solids basis. This syrup also provides 23% fewer calories than an equal quantity of a standard HFCS such as ISOSWEET 5500®.

This material could be blended with an HFCS with similar dry solids and fructose concentration (ISOSWEET 5500®) in order to adjust fiber level and calorie reduction to fit the needs of nearly any food product or beverage any application.

### Example 15

### Agglomerated Soluble Corn Fiber

Soluble Corn Fiber (SCF) was agglomerated using a Glatt ProCell 5 fluid bed agglomerator in top spray mode, with the GF batch insert. A 25% StarDri 10 (10 DE maltodextrin) solution was used as the binding solution.

Four hundred and fifty grams of the SCF were placed into the fluid bed and agglomerated with 200 g of the maltodextrin solution. The process was run with the following parameters: product temperature of 53° C., air volume of 70 m³/hr, atomization air at 1.5 bar, spray rate at about 8 g/min.

After 200 g of the solution was sprayed, the pump and heater were shut off and the product was dried for 1 minute. The finished product was then discharged from the chamber and sieved through a 10 mesh screen to remove large particles. This results in a product with lower bulk density (0.2 to 0.5 grams per cubic centimeter) compared to the raw SCF (˜0.8 g/cc).

Optionally, the SCF can be sieved through a 60 mesh prior to agglomeration. The product that goes through the screen can then be used to charge the bed. Using a finer starting product improves dispersibility of the final product.

### Example 16

### Agglomerated Soluble Corn Fiber with Sucralose

Soluble Corn Fiber (SCF) was agglomerated using a Glatt ProCell 5 in top spray mode, with the GF insert. A 25% StarDri 10 (10 DE maltodextrin) solution was used as the binding solution. A small amount of sucralose is added to the binder to add sweetness to the final product.

Four hundred and fifty grams of the SCF were placed into the fluid bed and agglomerated with 200 g of the maltodextrin solution. 1.6 g of sucralose was added to the binder solution before processing to make the final product 0.32% sucralose. The process was run with the following parameters: product temperature of 53° C., air volume of 70 m³/hr, atomization air at 1.5 bar, spray rate at about 8 g/min.

After 200 g of the solution was sprayed, the pump and heater were shut off and the product was dried for 1 minute. The finished product was then discharged from the chamber and sieved through a 10 mesh screen to remove large particles.

Optionally, the SCF can be sieved through a 60 mesh prior to agglomeration. The product that goes through the screen can then be used to charge the bed. Using a finer starting product improves dispersibility of the final product.

### Example 17

### Caramel Chew with Calcium Citrate

A chewable caramel-flavored calcium supplement was prepared with the following ingredients:

| | Grams |
|---|---|
| Sugar | 54 |
| Soluble Corn Fiber | 55 (syrup containing 72% dry solids) |
| Non-fat dry milk | 5 |
| Dairy butter | 27 |
| Salt | 0.4 |
| Vanilla flavor | 0.2 |
| Water | 25 |
| Calcium citrate | 80 |

The product was prepared as follows: Place sugar, non-fat dry milk and water in a cooking kettle. Stir until lump free. Add soluble corn fiber syrup. Cook to just above the boiling temperature (˜216° F.). Add butter with stirring. Cook until 236° F. Add salt, calcium and flavor. Pour onto oiled slab. Allow to cool and cut to desired shape in pieces weighing 5-6 grams each. Wrap.

### Example 18

### Caramel Chew with Calcium Carbonate

A chewable caramel-flavored calcium supplement was prepared with the following ingredients:

| | Grams |
|---|---|
| Sugar | 54 |
| Soluble Corn Fiber | 55 (syrup containing 72% dry solids) |
| Non-fat dry milk | 5 |
| Dairy butter | 27 |
| Salt | 0.4 |
| Vanilla flavor | 0.2 |
| Water | 25 |
| Calcium carbonate | 40 |

The product was prepared as follows: Place sugar, non-fat dry milk and water in a cooking kettle. Stir until lump free. Add soluble corn fiber syrup. Cook to just above the boiling temperature (˜216° F.). Add butter with stirring. Cook until 236° F. Add salt, calcium and flavor. Pour onto oiled slab. Allow to cool and cut to desired shape in pieces weighing 5-6 grams each. Wrap.

A two piece serving of either one of these chewable caramel flavored calcium supplements (Examples 17 and 18) provides 1 gram of calcium and 2 grams of dietary fiber at a total caloric intake of about 30 calories.

### Example 19

### Diet Cola Beverage

A control diet cola beverage was made by dissolving the following ingredients in water at the specified concentrations, followed by carbonation:

| Ingredient | % |
|---|---|
| Cola Flavor | 0.100 |
| Caramel DS | 0.050 |
| H₃PO₄ 85% | 0.060 |
| Na₃Citrate | 0.030 |
| Caffeine | 0.010 |
| Na Benzoate | 0.010 |
| Sucralose | 0.021 |

A diet cola beverage was made using a blend of pullulan and SCF by dissolving the following ingredients in water at the specified concentrations, followed by carbonation:

| Ingredient | % |
|---|---|
| SCF | 5.000 |
| Pullulan | 1.000 |
| Cola Flavor | 0.100 |
| Caramel DS | 0.050 |
| H₃PO₄ 85% | 0.060 |
| Na₃Citrate | 0.030 |
| Caffeine | 0.010 |
| Na Benzoate | 0.010 |
| Sucralose | 0.021 |

The two diet beverages were then tested by a trained sensory panel using coded sample identifiers. The panel found that the beverage that contained SCF and pullulan imparted both enhanced flavor and mouth feel compared to the control diet cola.

The preceding description of specific embodiments of the invention is not intended to be a list of every possible embodiment of the invention. Persons skilled in the art will recognize that other embodiments would be within the scope of the following claims.

What is claimed is:

1. An edible composition, comprising:
a starch-derived soluble fiber composition that is made from cereal grain and that comprises oligosaccharides that are digestion resistant, oligosaccharides that are slowly digestible, or a combination thereof, and
at least one material selected from fructose, pullulan, sorbitol, non-nutritive high-intensity sweetener, and combinations of two or more thereof.

2. The composition of claim 1, wherein the composition comprises sorbitol, pullulan, or a combination thereof.

3. The composition of claim 1, wherein the composition comprises a non-nutritive high-intensity sweetener.

4. The composition of claim 3, wherein the non-nutritive high-intensity sweetener is sucralose.

5. The composition of claim 1, wherein the soluble fiber composition is in particulate form, and wherein the particulates are held together by a binder.

6. The composition of claim 5, wherein the binder comprises a major amount of maltodextrin.

7. The composition of claim 1, wherein the starch-derived soluble fiber composition is derived from cereal grain.

8. The composition of claim 7, wherein the cereal grain is corn and the soluble fiber composition is a soluble corn fiber composition.

9. The composition of claim 1, wherein the soluble fiber composition is produced by a process comprising:
producing an aqueous composition that comprises at least one oligosaccharide and at least one monosaccharide by saccharification of starch derived from cereal grain;
fractionating the aqueous composition by a method comprising at least one of membrane filtering and sequential simulated moving bed chromatography to form a monosaccharide-rich stream and a digestion resistant oligosaccharide-rich stream; and
recovering the oligosaccharide-rich stream.

10. The composition of claim 9, wherein the oligosaccharide-rich stream comprises a minor amount of dextrose and fructose, and wherein the process further comprises contacting the oligosaccharide-rich stream with an isomerization enzyme such that at least some of the dextrose is converted to fructose, thereby producing an isomerized oligosaccharide-rich stream.

11. The composition of claim 9, wherein the oligosaccharide-rich stream comprises a minor amount of monosaccharides, and wherein the process further comprises hydrogenating the oligosaccharide-rich stream to convert at least some of the monosaccharides therein to alcohols, thereby producing a hydrogenated oligosaccharide-rich stream.

12. The composition of claim 9, wherein the process further comprises contacting the oligosaccharide-rich stream with a glucosidase enzyme such that at least some of any residual monosaccharides present in the stream are covalently bonded to oligosaccharides or other monosaccharides.

13. The composition of claim 1, wherein the soluble fiber composition is produced by a process comprising:
heating an aqueous feed composition that comprises at least one monosaccharide or linear saccharide oligomer derived from cereal grain, and that has a solids concentration of at least about 70% by weight, to a temperature of at least about 40° C.; and
contacting the feed composition with at least one catalyst that accelerates the rate of cleavage or formation of glucosyl bonds for a time sufficient to cause formation of non-linear saccharide oligomers, wherein a product composition is produced that contains a higher concentration of non-linear saccharide oligomers than linear saccharide oligomers.

14. The composition of claim 13, wherein the at least one catalyst is an enzyme that accelerates the rate of cleavage or formation of glucosyl bonds.

15. The composition of claim 14, wherein the enzyme is a glucoamylase enzyme composition.

16. The composition of claim 13, wherein the at least one catalyst is an acid.

17. The composition of claim 16, wherein the acid is hydrochloric acid, sulfuric acid, phosphoric acid, or a combination thereof.

18. The composition of claim 13, wherein the at least one catalyst comprises a combination of acid and enzyme, used sequentially in any order.

19. The composition of claim 13, wherein the feed composition has a solids concentration of about 70-99% and is maintained at a temperature of about 70-180° C. during the contacting with the acid.

20. The composition of claim 13, wherein the product composition comprises non-linear saccharide oligomers having a degree of polymerization of at least three in a concentration of at least about 50% by weight on a dry solids basis.

21. A food product comprising the edible composition of claim 1.

22. The food product of claim 21, wherein the edible composition is a replacement for sucrose in the food product.

23. The food product of claim 21, wherein the food product is selected from baked foods, breakfast cereal, dairy products, confections, jams and jellies, beverages, fillings, extruded and sheeted snacks, gelatin desserts, snack bars, cheese and cheese sauces, edible and water-soluble films, soups, syrups, sauces, dressings, creamers, icings, frostings, glazes, pet food, tortillas, meat and fish, dried fruit, infant and toddler food, and batters and breadings.

24. A method of decreasing the glycemic response of a mammal to a food product, comprising replacing a nutritive sweetener in the ingredients of the food product with the edible composition of claim 1.

25. The method of claim 24, wherein the nutritive sweetener is sucrose, corn syrup, high fructose corn syrup, or a combination thereof.

26. A single serving packaged sweetener composition, comprising:
a starch-derived soluble fiber composition that is made from cereal grain and that comprises oligosaccharides that are digestion resistant, oligosaccharides that are slowly digestible, or a combination thereof, and
a non-nutritive high-intensity sweetener;
wherein the composition is in a package that is adapted to be opened by a consumer.

27. The packaged sweetener composition of claim 26, wherein the composition further comprises at least one material selected from fructose, pullulan, sorbitol, and combinations of two or more thereof.

28. The packaged sweetener composition of claim 26, wherein the non-nutritive high-intensity sweetener is sucralose.

29. The packaged sweetener composition of claim 26, further comprising maltodextrin.

30. The packaged sweetener composition of claim 26, wherein the starch-derived soluble fiber composition comprises about 70-99% by weight of the packaged sweetener composition.

31. A corn syrup composition, comprising:
a starch-derived soluble fiber composition that is made from cereal grain and that comprises oligosaccharides that are digestion resistant, oligosaccharides that are slowly digestible, or a combination thereof,
fructose; and
a non-nutritive high-intensity sweetener.

32. The composition of claim 31, wherein the composition comprises about 35-50% by weight fructose and about 35-50% by weight of the soluble fiber composition on a dry solids basis.

33. The composition of claim 31, wherein the non-nutritive high-intensity sweetener is sucralose.

34. A sweetener composition, comprising a blend of high fructose corn syrup and a corn syrup composition of claim 31.

35. An edible calcium supplement, comprising:
a starch-derived soluble fiber composition that is made from cereal grain and that comprises oligosaccharides that are digestion resistant, oligosaccharides that are slowly digestible, or a combination thereof, and
at least one calcium compound.

36. The supplement of claim 35, wherein the calcium compound is calcium citrate, calcium carbonate, or a combination thereof.

37. A diet beverage, comprising:
a starch-derived soluble fiber composition that is made from cereal grain and that comprises oligosaccharides that are digestion resistant, oligosaccharides that are slowly digestible, or a combination thereof,
pullulan;
a non-nutritive high-intensity sweetener; and
at least one flavor.

38. The beverage of claim 37, wherein the non-nutritive high-intensity sweetener is sucralose.

39. The beverage of claim 37, wherein the beverage comprises about 3-7% by weight of the starch-derived soluble fiber composition and about 0.1-3% by weight pullulan.

40. An edible composition, comprising particulates that comprise an agglomeration of:
a starch-derived soluble fiber composition that is made from cereal grain and that comprises oligosaccharides that are digestion resistant, oligosaccharides that are slowly digestible, or a combination thereof, and
maltodextrin.

41. The edible composition of claim 40, wherein the particulates further comprise a non-nutritive high-intensity sweetener.

42. The edible composition of claim 41, wherein the non-nutritive high-intensity sweetener is sucralose.

43. The edible composition of claim 40, wherein the composition has a bulk density of 0.1-0.85 g per cubic centimeter.

44. The edible composition of claim 43, wherein the composition has a bulk density of 0.45-0.65 g per cubic centimeter.

45. A process for preparing an edible composition, comprising:
combining (a) an aqueous maltodextrin solution and (b) a starch-derived soluble fiber composition that is made from cereal grain and that comprises oligosaccharides that are digestion resistant, oligosaccharides that are slowly digestible, or a combination thereof, to form a mixture; and
agglomerating the mixture to form particulates.

46. The process of claim 45, wherein the mixture further comprises a non-nutritive high-intensity sweetener.

47. The process of claim 46, wherein the non-nutritive high-intensity sweetener is sucralose.

48. The process of claim 45, wherein the particulates have a bulk density of 0.1-0.85 g per cubic centimeter.

49. The process of claim 45, wherein the particulates have a bulk density of 0.45-0.65 g per cubic centimeter.

50. The process of claim 45, wherein the mixture is agglomerated by spray agglomeration.

51. A process for preparing an edible composition, comprising:
combining (a) a starch-derived soluble fiber composition that is made from cereal grain and that comprises oligosaccharides that are digestion resistant, oligosaccharides that are slowly digestible, or a combination thereof, and (b) at least one material selected from fructose, pullulan, sorbitol, non-nutritive high-intensity sweetener, and combinations of two or more thereof, to form a mixture; and
agglomerating the mixture to form particulates.

52. An edible composition, comprising particulates that comprise an agglomeration of:
a starch-derived soluble fiber composition that is made from cereal grain and that comprises oligosaccharides that are digestion resistant, oligosaccharides that are slowly digestible, or a combination thereof, and
at least one material selected from fructose, pullulan, sorbitol, non-nutritive high-intensity sweetener, and combinations of two or more thereof.
